(19) United States
(12) Patent Application Publication
(10) Pub. No.: US 2025/0348367 A1
(43) Pub. Date: Nov. 13, 2025

(54) ELECTRONIC DATA INTERCHANGE SERVICE AUTOSCALER FOR ELECTRONIC INFORMATION EXCHANGE PLATFORM

(71) Applicant: OPEN TEXT CORPORATION, Waterloo (CA)

(72) Inventor: Gregory Pekofsky, Dollard-Des-Ourmeaux (CA)

(21) Appl. No.: 18/660,026

(22) Filed: May 9, 2024

(51) Int. Cl. G06F 9/54

(52) U.S. Cl. CPC G06F 9/541; G06F 9/546

(57) ABSTRACT

An orchestration engine receives an itinerary requiring a managed service provided by an electronic information exchange platform to process a document. The itinerary defines a process model specific to a document type of the document. The orchestration engine is operable to determine whether an adapter for the managed service is currently in use. Responsive to not finding the adapter for the managed service currently in use, the orchestration engine communicates or otherwise indicates to an auto-scaler, a need for the adapter for the managed service. Responsive to the need for the adapter, the auto-scaler automatically scales up deployment of the adapter to a minimum of two computing units for high availability of the managed service. Once the adapter is ready, the managed service operates on the document per the itinerary.

### TECHNICAL FIELD

This disclosure relates generally to data processing in a network computing environment. More particularly, this disclosure relates to systems and methods for just-in-time scaling up an electronic data interchange service on an electronic information exchange platform.

### BACKGROUND OF THE RELATED ART

Today, enterprises and entities alike recognize the tremendous cost savings by exchanging business documents with their trading partners via an electronic communication method referred to as the Electronic Data Interchange (EDI). An electronic information exchange platform operates in a network environment and has the necessary resources (e.g., hardware, software, personnel, etc.) to provide managed services that support EDI. The OpenText GXS Trading Grid® (which is referred to herein as the “Trading Grid”), available from Open Text, headquartered in Waterloo, Canada, is an example of such an electronic information exchange platform.

These managed services enable the real-time flow or exchange of information electronically in the network environment in a secure, fast, and reliable manner, between and among disparate operating units. Non-limiting examples of managed services may include translation services, format services, copy services, email services, document tracking services, messaging services, document transformation services (for consumption by different computers), regulatory compliance services (e.g., legal hold, patient records, tax records, employment records, etc.), encryption services, data manipulation services (e.g., validation), etc.

Implemented as microservices, the Trading Grid currently deploys over hundreds of different managed services to each instance. In terms of hardware, each deployment can cost hundreds of central processing units (CPUs) and gigabytes (GBs) of memory.

### SUMMARY OF THE DISCLOSURE

An object of the invention is to reduce the resources, particularly hardware resources, needed in providing managed services to disparate networked computer systems through an electronic information exchange platform. According to embodiments, this object is achieved in an electronic data interchange service auto-scaler (which is referred to herein as the “auto-scaler”) that is particularly configured for just-in-time scaling up a heretofore never used electronic data interchange service on an electronic information exchange platform.

In some embodiments, a method for just-in-time auto-scaling up an electronic data interchange service can comprise receiving, by an orchestration engine running on an electronic information exchange platform, an itinerary requiring a managed service provided by the electronic information exchange platform. The itinerary defines a process model specific to a document type and the managed service is one of a plurality of managed services provided by the electronic information exchange platform.

In some embodiments, the orchestration engine determines whether an adapter for the managed service is currently in use and, responsive to not finding the adapter for the managed service currently in use, communicates to an auto-scaler adapter a need for the adapter for the managed service. Responsive to the need for the adapter, an auto-scaler automatically scales up deployment of the adapter to a minimum of two computing units for high availability of the managed service. Each computing unit can be a pod, a container, or a set of tightly coupled containers. In some embodiments, the automatically scaling up comprises making a call to an application programming interface (API) of a Kubernetes cluster, wherein the API is operable to deploy the minimum of two computing units for the adapter.

In some embodiments, the orchestration engine generates and sends an alert message about the adapter through a channel internal to the electronic information exchange platform. This is so that an operator of the electronic information exchange platform can take action to ensure that the adapter for the managed service is included in a subsequent deployment, since there is a demonstrated need for the particular managed service.

In some embodiments, the orchestration engine queues a service request message for the managed service in a service request queue. The service request message is later consumed by the adapter once the pods are deployed to the adapter so as to support the managed service.

One embodiment comprises a system comprising a processor and a non-transitory computer-readable storage medium that stores computer instructions translatable by the processor to perform a method substantially as described herein. Another embodiment comprises a computer program product having a non-transitory computer-readable storage medium that stores computer instructions translatable by a processor to perform a method substantially as described herein. Numerous other embodiments are also possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, and/or rearrangements may be made within the scope of the disclosure without departing from the spirit thereof, and the disclosure includes all such substitutions, modifications, additions, and/or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 depicts a diagrammatic representation of an electronic information exchange platform operating in a computer network environment and providing managed services to disparate computer systems.

FIG. 2 depicts a diagrammatic representation of an example of a backend system that provides an orchestration service according to some embodiments disclosed herein.

FIG. 3 depicts an architectural diagram that illustrates by example how to automatically scale up a managed service when first needed, according to some embodiments disclosed herein.

FIG. 4 shows a result of automatically scaling up a managed service when first needed, according to some embodiments disclosed herein.

FIG. 5 depicts an example of an asynchronous itinerary execution according to some embodiments.

FIG. 6 depicts an example of a synchronous itinerary execution according to some embodiments.

FIG. 7 depicts a diagrammatic representation of a distributed network computing environment where embodiments disclosed can be implemented.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions, and/or rearrangements within the spirit and/or scope of the underlying inventive concept will become apparent to those skilled in the art from this disclosure.

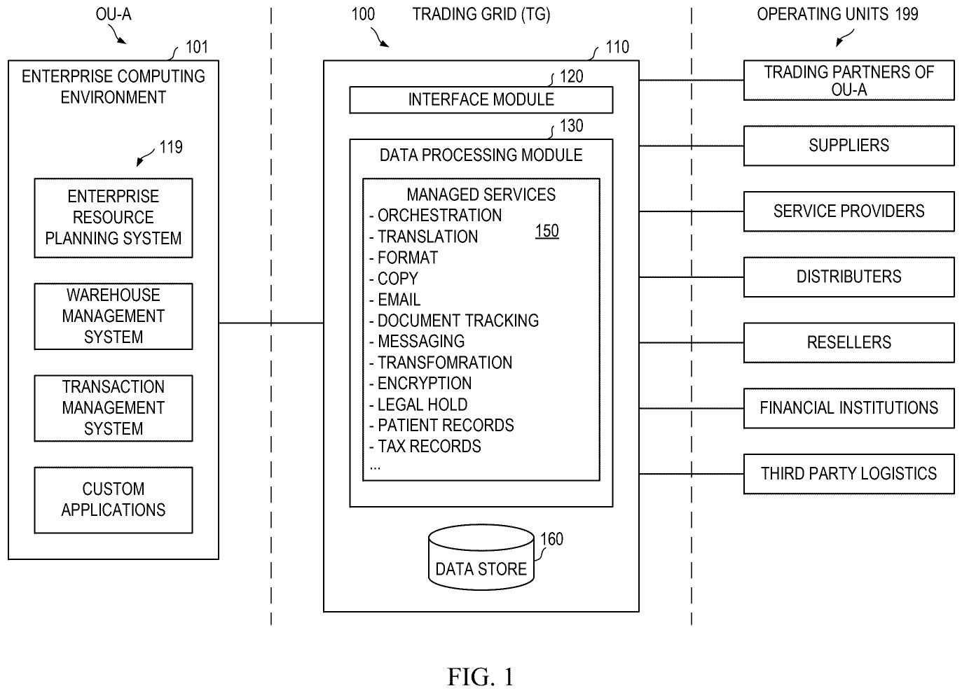

FIG. 1 depicts a diagrammatic representation of an example of an electronic information exchange platform, referred to as Trading Grid 100, operating in a computer network environment. The Trading Grid operates to facilitate the real-time flow or exchange of information between disparate entities regardless of standards preferences, spoken languages, or geographic locations. The Trading Grid may be embodied on server machines that support the electronic communication method (e.g., EDI) used by various computers that are independently owned and operated by different entities. Data formats supported by the Trading Grid may include EDI, Extensible Markup Language (XML), RosettaNet, EDI-INT, flat file/proprietary format, etc. Supported network connectivity may include dial-up, frame relay, AS2, leased line, Internet, etc. Supported delivery methods may include store-and-forward mailbox, event-drive delivery, etc. Supported transport methods may include Hypertext Transfer Protocol (HTTP), File Transfer Protocol (FTP), and Simple Mail Transfer Protocol (SMTP), etc. Supported network security protocols may include Secure Socket Layer (SSL), Secure/Multipurpose Internet Mail Extensions (S/MIME), Internet Protocol Security (IPSEC), Virtual Private Network (VPN), Pretty Good Privacy (PGP) encryption protocol, etc.

In the example shown in FIG. 1, a system 110 operating on Trading Grid 100 may comprise a plurality of modules, including interface module 120, data processing module 130, and data store 160. In some embodiments, data processing module 130 may be configured for providing and managing a very large number (e.g., 135 or more) of services 150 performed by backend systems operating on Trading Grid 100. Interface module 120 may be configured for providing user interfaces for registered operating units (OUs) such as OU-A with access to managed services 150. Non-limiting examples of services 150 may include, but are not limited to, translation services, format services, copy services, email services, document tracking services, messaging services, document transformation services (for consumption by different computers), regulatory compliance services (e.g., legal hold, patient records, tax records, employment records, etc.), encryption services, data manipulation services (e.g., validation), etc.

In this disclosure, an operating unit (OU) represents a company, a corporation, an enterprise, an entity, or a division thereof. An example of a network environment may include a distributed computer network, a cloud computing environment, or the Internet. As an example, OU-A may own and operate enterprise computing environment 101 which is separate and independent of Trading Grid 100. From the perspective of Trading Grid 100 or system 110, OU-A is a registered enterprise customer and, thus, systems 119 of OU-A which utilize services 150 provided by system 110 are client systems of system 110. Client systems 119 operating in enterprise computing environment 101 may use one or more services 150 to communicate with various systems and/or devices operating in computing environments 199 owned and operated by trading partners (TPs) of OU-A. These TPs of OU-A can be, but need not be, OUs as well. Additional information about the Trading Grid can be found in U.S. Pat. No. 10,241,985, entitled “SYSTEMS AND METHODS FOR INTELLIGENT DOCUMENT-CENTRIC ORCHESTRATION THROUGH INFORMATION EXCHANGE PLATFORM,” which is incorporated by reference herein.

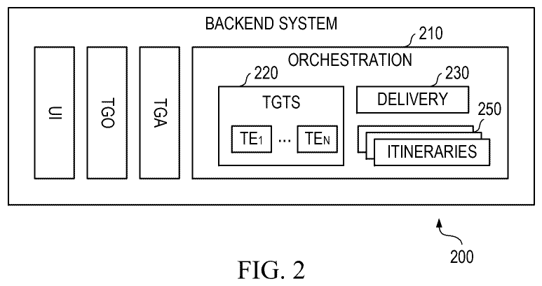

FIG. 2 depicts a diagrammatic representation of an example of a backend system that provides an orchestration service according to some embodiments disclosed herein. In this example, backend system 200 may comprise various system components such as user interface (UI), Trading Grid Online application (TGO), and Trading Grid Administration (TGA). A document sent by OU-A can be routed through the UI, the TGO, and the TGA to orchestration service 210. TGO is the location for document-centric applications (e.g., active invoice, compliance, active communities, active orders, etc.), living within the TGO space. TGA is a mechanism to efficiently set up data flow tuples used by the underlying information exchange platform based on the sender, receiver, and document type contained in each data flow tuple. These data flow tuples are associated with itineraries 250 based on metadata (e.g., sender/receiver/document type) about a respective data flow. Orchestration service 210 provides an ability to define itineraries (e.g., using an assembly language).

Delivery service 230, which is part of orchestration service 210, may operate to process the document according to itinerary 250 associated with OU-A. Itinerary 250 may define a process model specific to a document type of the document. In some embodiments, an itinerary can be an XML document that describes a processing model for a particular send/receiver/document type and may include one or more processes. For example, itinerary 250 may include a process for translating the document using one or more translation engines (TE₁. . . . TE_{N}) of Trading Grid Translation Services (TGTS) 220. TGTS 220 represents an example of an orchestrated service that can “live” in an itinerary—any orchestrated service can live in an itinerary as a process.

As alluded to above, at any given time, there might be many zones on the Trading Grid. A zone refers to the deployment of an instance of the Trading Grid that is dedicated to a customer or shared among a set of customers (e.g., in the United States or Europe). One data center can host multiple zones. That is, sometimes a TG zone is shared by OUs and sometimes a TG zone is used by an individual OU. Generally, files received from one OU (i.e., the sender) is transformed using one or more managed services and sent to another OU or OUs (i.e., the receiver or receivers). Many of these managed services require setup (onboarding) for the sender and/or the receiver. A problem here is that many of these managed services are deployed and yet never used, taking up service execution space, memory, processing power, etc. This inefficacy results in a significant and impactful waste of precious resources as well as time and money.

To solve this resource-wasting problem, this disclosure provides a just-in-time, need-based approach to starting a new service in a TG zone (i.e., scaling up an entity-specific adapter for a managed service that the particular TG zone was not using). For example, a TP of an OU may send a request to the OU through the Trading Grid. The Trading Grid processes the request and determines a data flow tuple that contains the sender (i.e., the TP), the receiver (i.e., the OU), and a document type for a document referenced in the request. The Trading Grid (e.g., system 100 shown in FIG. 1) determines that the request requires the document to be processed by a managed service that has not been used in the particular TG involving the OU and the TP. In response, the Trading Grid calls a service auto-scaler to deploy the managed service just in time when the heretofore never used managed service is needed (first use). For high availability (HA), the service auto-scaler assigns multiple (e.g., at least two pods) to an adapter which supports the managed service. Pods are the smallest deployable units of computing that can be created and managed in a Kubernetes cluster. For instance, a pod can be composed of multiple, tightly coupled containers or a single container. This just-in-time service auto-scaling approach can result in savings in compute resources and server usage. To this end, the invention disclosed herein provides a green technology that automatically scales up electronic data interchange services only when first needed.

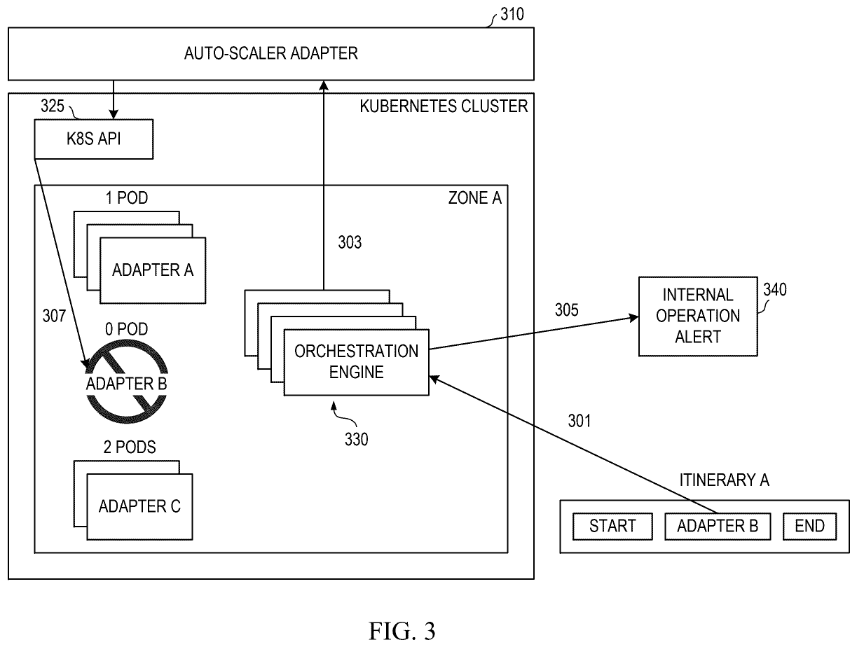

FIG. 3 depicts an architectural diagram that illustrates by example how to automatically scale up a managed service when first needed, according to some embodiments disclosed herein. In this example, an itinerary A (e.g., itinerary 250 shown in FIG. 2), which involves a managed service (which is referred to as Adapter B), is executed by an orchestration engine 330 running in a Kubernetes cluster (301). As a non-limiting example, Adapter B is configured for providing a document conversion service. At this point, it does not matter whether the orchestration engine is an asynchronous engine or a synchronous engine. A Kubernetes (K8s) cluster is a set of nodes that run containerized applications. Kubernetes clusters are known to those skilled in the art and thus are not further described herein.

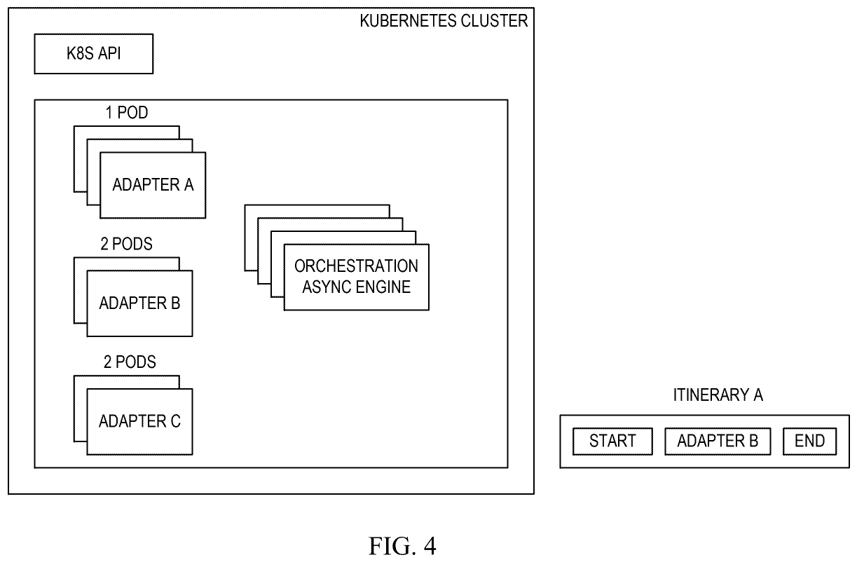

The orchestration engine 330 recognizes that Adapter B has no associated Kubernetes pods (which are referred to hereinafter as “pods”) in the zone (e.g., Zone A) and indicates to an auto-scaler adapter 310 that Adapter B deployment should scale up the number of pods for Adapter B to 2 (303). Meanwhile, the orchestration engine 330 sends an alert to indicate what has happened (305). This alert can be sent through an internal channel (e.g., by email, by messaging, by notification, via a user interface, etc.) to the operator of the Trading Grid (“operations”) so that they can inform the associated owning team of the adapter and orchestration to make sure their subsequent deployments are updated (e.g., so as to include Adapter B in the subsequent deployments). Through a K8S application programming interface (API) 325, auto-scaler adapter 310 is operable to instruct the Kubernetes cluster to scale up Adapter B's deployment to two pods for high availability (307). FIG. 4 shows a result of an auto-scaler scaling up Adapter B's deployment to two pods.

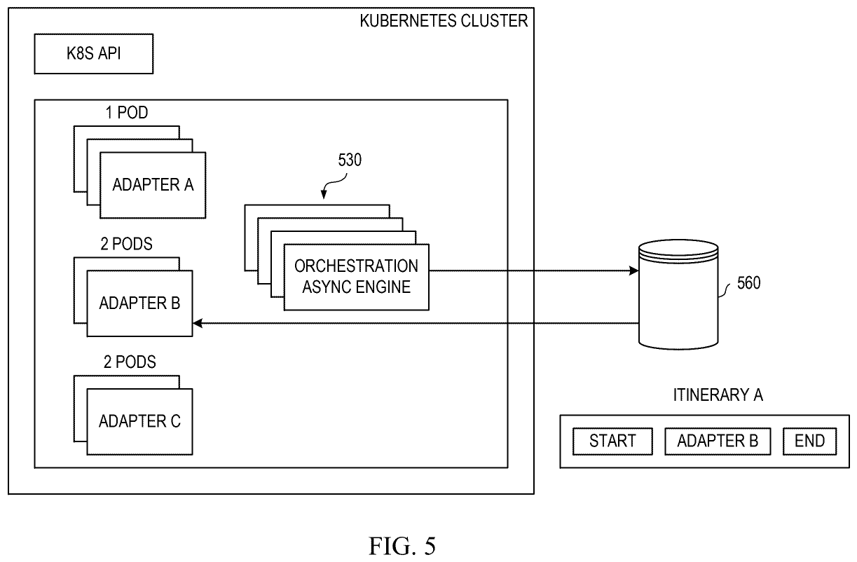

FIG. 5 depicts an example of an asynchronous itinerary execution according to some embodiments. In the example of FIG. 5, while Adapter B's deployment is scaling up, the service request message for Adapter B is sent from an asynchronous orchestration engine 530 to a service request queue 560. In this case, when Adapter B is ready, it will consume the service request message stored in service request queue 560 and execute the requested service.

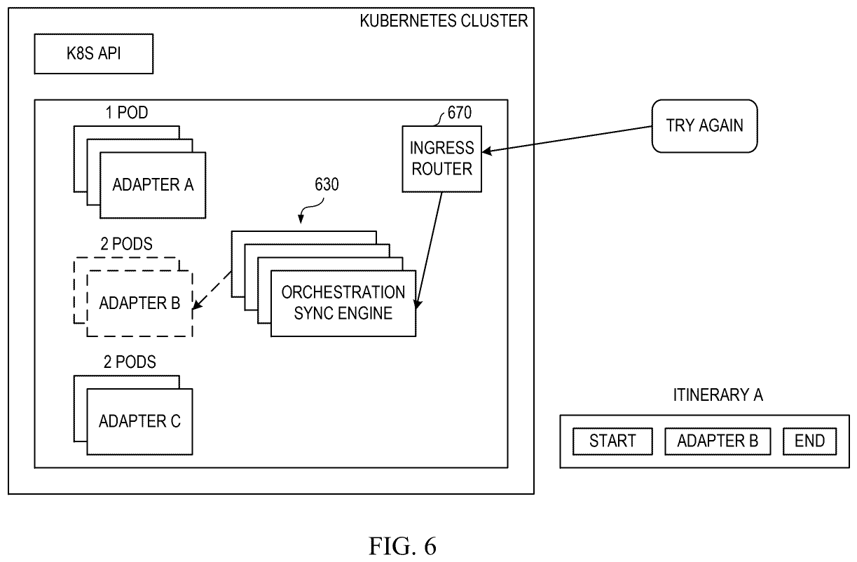

FIG. 6 depicts an example of a synchronous itinerary execution according to some embodiments. In some cases, an itinerary is routed through an ingress router 670 to a synchronous orchestration engine 630. If Adapter B is not available, a failure or error message will be sent. On failure, ingress router 670 may try sending the itinerary to synchronous orchestration engine 630 again.

In embodiments disclosed herein, the auto-scaling of a managed service (or an adapter thereof) is triggered by a data flow (e.g., in executing an itinerary that involves the managed service) just in time when the managed service is needed by the data flow. For high availability, the scaling up results in deploying at least two pods for the requested service. The auto-scaling approach disclosed herein allows an instance of the Trading Grid to be deployed with a minimum set of default managed services and then automatically start each new managed service on a need-only basis, one adapter at a time. No pods were deployed for unused managed services, thereby reducing waste of resources that otherwise would have been consumed had these unused managed services been deployed.

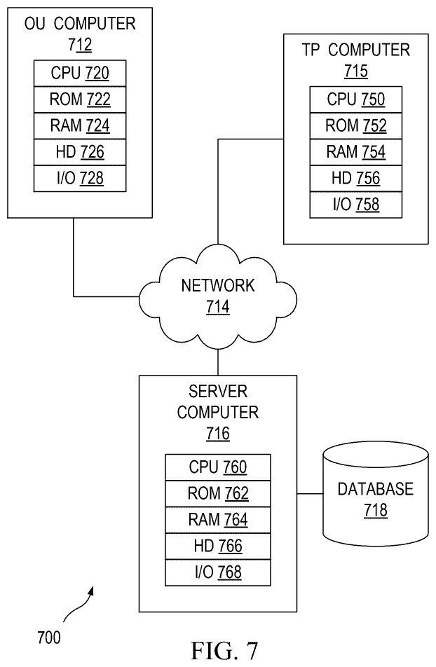

FIG. 7 depicts a diagrammatic representation of a distributed network computing environment where embodiments disclosed can be implemented. In the example illustrated, network computing environment 700 includes network 714 that can be bi-directionally coupled to first enterprise computer 712, second enterprise computer 715, and Trading Grid computer 716. Trading Grid computer 716 can be bi-directionally coupled to data store 718. Network 714 may represent a combination of wired and wireless networks that network computing environment 700 may utilize for various types of network communications known to those skilled in the art.

For the purpose of illustration, a single system is shown for each of first enterprise computer 712, second enterprise computer 715, and Trading Grid computer 716. However, with each of first enterprise computer 712, second enterprise computer 715, and Trading Grid computer 716, a plurality of computers (not shown) may be interconnected to each other over network 714. For example, a plurality of first enterprise computers 712 and a plurality of second enterprise computers 715 may be coupled to network 714. First enterprise computers 712 may include data processing systems for communicating with Trading Grid computer 716. Second enterprise computers 715 may include data processing systems for individuals whose jobs may require them to configure services used by first enterprise computers 712 in network computing environment 700.

First enterprise computer 712 can include central processing unit (“CPU”) 720, read-only memory (“ROM”) 722, random access memory (“RAM”) 724, hard drive (“HD”) or storage memory 726, and input/output device(s) (“I/O”) 728. I/O 729 can include a keyboard, monitor, printer, electronic pointing device (e.g., mouse, trackball, stylus, etc.), or the like. First enterprise computer 712 can include a desktop computer, a laptop computer, a personal digital assistant, a cellular phone, or nearly any device capable of communicating over a network. Second enterprise computer 715 may be similar to first enterprise computer 712 and can comprise CPU 750, ROM 752, RAM 754, HD 756, and I/O 758.

Likewise, Trading Grid computer 716 may include CPU 760, ROM 762, RAM 764, HD 766, and I/O 768. Trading Grid computer 716 may include one or more backend systems configured for providing a variety of services to first enterprise computers 712 over network 714. These services may utilize data stored in data store 718. Many other alternative configurations are possible and known to skilled artisans.

Each of the computers in FIG. 7 may have more than one CPU, ROM, RAM, HD, I/O, or other hardware components. For the sake of brevity, each computer is illustrated as having one of each of the hardware components, even if more than one is used. Each of computers 712, 715, and 716 is an example of a data processing system. ROM 722, 752, and 762; RAM 724, 754, and 764; HD 726, 756, and 766; and data store 718 can include media that can be read by CPU 720, 750, or 760. Therefore, these types of memories include non-transitory computer-readable storage media. These memories may be internal or external to computers 712, 715, or 716.

Portions of the methods described herein may be implemented in suitable software code that may reside within ROM 722, 752, or 762; RAM 724, 754, or 764; or HD 726, 756, or 766. In addition to those types of memories, the instructions in an embodiment disclosed herein may be contained on a data storage device with a different computer-readable storage medium, such as a hard disk. Alternatively, the instructions may be stored as software code elements on a data storage array, magnetic tape, floppy diskette, optical storage device, or other appropriate data processing system readable medium or storage device.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein. The invention can also be employed in distributed computing environments, where tasks or modules are performed by remote processing devices, which are linked through a communications network such as a local area network (LAN), wide area network (WAN), and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer-readable medium, hardware circuitry or the like, or any combination and that may be translatable by one or more server machines. Examples of a non-transitory computer-readable medium are provided below in this disclosure.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer readable medium (for example, a disk, CD-ROM, a memory, etc.). Alternatively or additionally, the computer-executable instructions may be stored as software code components on a direct access storage device array, magnetic tape, floppy diskette, optical storage device, or other appropriate computer-readable medium or storage device.

Any suitable programming language can be used to implement the routines, methods, or programs of embodiments of the invention described herein, including C, C++, Java, JavaScript, HyperText Markup Language (HTML), Python, or any other programming or scripting code. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps, and operations described herein can be performed in hardware, software, firmware, or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code any of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. The functions of the invention can be achieved in many ways. For example, distributed or networked systems, components, and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory. Such computer-readable medium shall be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any hardware system, mechanism or component that processes data, signals or other information. A processor can include a system with a central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the claims that follow, the meaning of “in” includes “in” and “on” unless the context clearly dictates otherwise.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention. The scope of the present disclosure should be determined by the following claims and their legal equivalents.

What is claimed is:

1. A method, comprising:
receiving, by an orchestration engine running on an electronic information exchange platform, an itinerary requiring a managed service provided by the electronic information exchange platform;
determining, by the orchestration engine, whether an adapter for the managed service is currently in use;
responsive to not finding the adapter for the managed service currently in use, communicating, by the orchestration engine to an auto-scaler, a need for the adapter for the managed service; and
responsive to the need for the adapter, automatically scaling up, by the auto-scaler, deployment of the adapter to a minimum of two computing units.

2. The method according to claim 1, wherein the automatically scaling up comprises making a call to an application programming interface (API) of a Kubernetes cluster, wherein the API is operable to deploy the minimum of two computing units for the adapter.

3. The method according to claim 1, further comprising:
generating and sending an alert message about the adapter through a channel internal to the electronic information exchange platform.

4. The method according to claim 1, further comprising:
queuing a service request message for the managed service in a service request queue, wherein the service request message is consumed by the adapter once the two computing units are deployed to the adapter so as to support the managed service.

5. The method according to claim 1, wherein the orchestration engine operates in a zone of the electronic information exchange platform.

6. The method according to claim 1, wherein each of the computing units comprises a pod, a container, or a set of tightly coupled containers.

7. The method according to claim 1, wherein the itinerary defines a process model specific to a document type and wherein the managed service is one of a plurality of managed services provided by the electronic information exchange platform.

8. A system, comprising:
a processor;
a non-transitory computer-readable medium; and
instructions stored on the non-transitory computer-readable medium and translatable by the processor for:
receiving an itinerary requiring a managed service provided by an electronic information exchange platform;
determining whether an adapter for the managed service is currently in use;
responsive to not finding the adapter for the managed service currently in use, communicating, to an auto-scaler, a need for the adapter for the managed service; and
responsive to the need for the adapter, automatically scaling up deployment of the adapter to a minimum of two computing units.

9. The system of claim 8, wherein the automatically scaling up comprises making a call to an application programming interface (API) of a Kubernetes cluster, wherein the API is operable to deploy the minimum of two computing units for the adapter.

10. The system of claim 8, wherein the instructions are further translatable by the processor for:
generating and sending an alert message about the adapter through a channel internal to the electronic information exchange platform.

11. The system of claim 8, wherein the instructions are further translatable by the processor for:
queuing a service request message for the managed service in a service request queue, wherein the service request message is consumed by the adapter once the two computing units are deployed to the adapter so as to support the managed service.

12. The system of claim 8, wherein the determining and the communicating are performed by an orchestration engine operating in a zone of the electronic information exchange platform.

13. The system of claim 8, wherein each of the computing units comprises a pod, a container, or a set of tightly coupled containers.

14. The system of claim 8, wherein the itinerary defines a process model specific to a document type and wherein the managed service is one of a plurality of managed services provided by the electronic information exchange platform.

15. A computer program product comprising a non-transitory computer-readable medium storing instructions translatable by a processor for:
receiving an itinerary requiring a managed service provided by an electronic information exchange platform;
determining whether an adapter for the managed service is currently in use;
responsive to not finding the adapter for the managed service currently in use, communicating, to an auto-scaler, a need for the adapter for the managed service; and
responsive to the need for the adapter, automatically scaling up deployment of the adapter to a minimum of two computing units.

16. The computer program product of claim 15, wherein the automatically scaling up comprises making a call to an application programming interface (API) of a Kubernetes cluster, wherein the API is operable to deploy the minimum of two computing units for the adapter.

17. The computer program product of claim 15, wherein the instructions are further translatable by the processor for:
generating and sending an alert message about the adapter through a channel internal to the electronic information exchange platform.

18. The computer program product of claim 15, wherein the instructions are further translatable by the processor for:
queuing a service request message for the managed service in a service request queue, wherein the service request message is consumed by the adapter once the two computing units are deployed to the adapter so as to support the managed service.

19. The computer program product of claim 15, wherein each of the computing units comprises a pod, a container, or a set of tightly coupled containers.

20. The computer program product of claim 15, wherein the itinerary defines a process model specific to a document type and wherein the managed service is one of a plurality of managed services provided by the electronic information exchange platform.
